(19) United States
(12) Patent Application Publication
(10) Pub. No.: US 2007/0280780 A1
(43) Pub. Date: Dec. 6, 2007

(54) Fitting Device

(76) Inventors: Manfred Bruehl, Kuchen (DE); Otto Mueller, Illerkirchberg (DE); Jutta Reiss, Neubrunn (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/596,505

(22) PCT Filed: May 11, 2005
(86) PCT No.: PCT/EP05/05101

§ 371 Date: Nov. 13, 2006

(30) Foreign Application Priority Data
May 12, 2004 (DE) 102004023442.6
Jan. 12, 2005 (DE) 102005001453.4

(51) Int. Cl. F16B 17/00

(52) U.S. Cl. 403/179

(57) ABSTRACT

The present invention relates to a fitting device (10) for a tube-shaped workpiece (27) for use in internal combustion engine facilities. The fitting device (10) has a basic body (16) for the reception of the tube-shaped workpiece (27), the basic body (16) being positioned in the opening of the laminar component (15) and at least a part of the basic body (16) essentially being movable in a plane which is oriented parallel to the plane of the opening. Furthermore, the fitting device (10) has a frame element which holds the basic body (16) and is supported on the opening edge of the laminar component (15). The fitting device (10) is arranged in such a way that it covers the opening of the laminar component (15) after reception of the tube-shaped workpiece (27).

The present invention relates to a fitting device for a tube-shaped workpiece for use in internal combustion engine facilities. In the following, a fitting device is to be understood as any type of fitting or any guide, through which a tube-shaped workpiece may be spatially oriented in the region of an internal combustion engine facility The tube-shaped workpiece may be held in the internal combustion engine facility exclusively by the fitting device or in connection with other means suitable for this purpose.

In internal combustion engine facilities tube-shaped workpieces are frequently positioned, because of the ever more compact construction in engines and engine facilities, in such a way that they are either guided through openings in other components of the internal combustion engine facility or rest with one free end against other components of the internal combustion engine facility and must be attached there. In the further course of events, the term internal combustion engine facility is considered as comprising both an internal combustion engine and also the associated exhaust system, particularly exhaust manifold, catalytic converter, and possibly turbocharger.

For example, measuring the oxygen content in the exhaust duct through oxygen measuring probes, i.e., lambda probes, to achieve exhaust gases which are as free of contaminants as possible, is known in motor vehicles. For this purpose, the lambda probes are positioned in an exhaust duct of an internal combustion engine facility, only the region of the probe which comprises the sensor being positioned within the exhaust duct, while the remaining region of the probe, to which the connection sockets are attached, for example, is positioned outside the exhaust duct The lambda probe may itself be a tube-shaped workpiece or may be contained in a tube-shaped workpiece. Further embodiments of the tube-shaped workpiece comprise, for example, tube-shaped workpieces having clamping arrangements and tubular connection elements and fastening elements, which may have threads on at least some sections. The tube-shaped workpiece may have any arbitrary cross-section in principle, i.e., the cross-section does not necessarily have to be circular.

In internal combustion engine facilities, among other things, laminar components are used which, because of their laminar design and the compact construction of internal combustion engine facilities, often represent an obstruction for tube-shaped workpieces of the internal combustion engine facility, so that the latter must be guided through the laminar components. Thus, for example, in automobile manufacture, to shield temperature-sensitive components and assemblies from heat sources, particularly components which guide exhaust gases, in general laminar heat shields are positioned between the heat sources and the temperature-sensitive components. In the region of the exhaust gas system, the heat shields are often positioned in such a way that the lambda probes project beyond them and therefore an opening must be arranged in the heat shields, through which the lambda probe may be guided. The opening must have a larger diameter than the diameter of the lambda probe, i.e., offer sufficient tolerance so that strains and finally damage of the components do not occur due to movements of the components caused by vibration of the internal combustion engine facility and, in addition, due to temperature-dependent expansions of the components. The larger diameter is additionally used to make it easier to install and/or uninstall the tube-shaped workpiece on the internal combustion engine facility. An example of this is the installation and/or uninstallation of the lambda probe using a wrench on the exhaust manifold.

Leakages occur in this region due to the larger diameter of the opening in comparison to the workpiece which is guided through the opening. Particularly ill openings through heat shields, chimney effects may occur due to the large temperature differences of the surrounding air of the two sides of the heat shield, due to which hot air flows into regions of temperature-sensitive components and damage of these components may occur (e.g., melting of cable insulation, deformation of plastic components, etc.). In order to overcome this problem, constructions are known in which the part of the tube-shaped workpiece which projects through the opening of another component is provided with an insulating stocking which seals the opening. This has the disadvantageous effect that the permanent attachment of such an insulating stocking is very complex and therefore significantly increases the complexity of the manufacturing process of such arrangements.

With tube-shaped workpieces which rest against laminar components and/or are attached thereto, strains and finally damage to the components may occur due to the different thermal expansion coefficients of the different components and due to vibration of the internal combustion engine facility.

The present invention is therefore based on the object of providing a fitting device for a tube-shaped workpiece, which achieves an optimum tolerance equalization for the opening in a laminar component necessary for the installation of the tube-shaped workpiece and also achieves a reliable and permanent covering of this opening. In addition, the fitting device is to offer sufficient tolerance for the movements of the tube-shaped workpiece, in order to thus reduce strains and avoid damage to the components.

This object is achieved according to the present invention by the fitting device as claimed in claim 1. The fitting device has at least one basic body having a reception area for the reception of the tube-shaped workpiece, the basic body being arranged in the region of an opening of a laminar component of the internal combustion engine facility and at least a part of the basic body essentially being movable in a movement plane which is oriented parallel to the plane of the opening. In addition, the fitting device has a frame element which holds the basic body and is supported in the boundary region of the opening of the laminar component Furthermore, the fitting device is arranged in such a way that it covers the opening of the laminar component after reception of the tube-shaped workpiece.

Advantageous embodiments of the present invention are specified in the dependent claims.

Through the arrangement of the frame element and the basic body, the opening in the laminar component is covered and the fitting device therefore acts as a seal for this opening. Leakages are thus avoided. Furthermore, because at least a part of the basic body is movable in the region of the opening in a plane which is positioned parallel to the plane of the opening of the laminar component, the fitting device provides sufficient tolerance for the movements of the tube-shaped workpiece to be received by the basic body, so that strains on the workpiece or on the fitting device are avoided. The plane in which at least a part of the basic body is movable is referred to the following as the movement plane. In addition, the expression “a plane which is positioned parallel to the plane of the opening in the laminar component”, is to comprise both planes parallel to the opening plane and also the opening plane itself in the scope of the present invention.

The basic body is not fixed on a specific shape in principle. It may be arranged both in one piece and may also be arranged from multiple individual elements, in particular as multilayered. In principle, the basic body is not restricted to a movement in the movement plane, but rather may be arranged in such a way that movements in all three dimensions, including tilting movements in relation to the movement plane, may be executed. The frame element may be supported on the laminar component on one side or on both sides.

The fitting device according to the present invention is preferably positioned in openings of heat shields in the region of internal combustion engine facilities. Frequently, these heat shields are located in the region of the exhaust gas system, and the tube-shaped workpieces which are to be received by the fitting device and/or pass through it are preferably sensors, particularly lambda probes. It is advantageous in this case that a chimney effect is avoided and temperature-sensitive components on the side of the heat shields facing away from heat source are not damaged and, in addition, the sensors which are guided through the fitting device are also protected themselves.

In a preferred embodiment, the basic body is made of metal or a metal alloy, especially preferably from copper or steel. These materials are especially suitable both due to their good shaping properties and due to their heat resistance. In addition, high-temperature-resistant fiber-reinforced materials may be used for implementing the basic body. A combination of these materials is also possible. The frame element of the fitting device according to the present invention also preferably comprises the materials cited for the basic body.

In an advantageous embodiment of the present invention, the edge of the frame element is arranged as a flange. The flange is positioned in this case in such a way that the flange of the fitting device rests on the boundary region of the opening of the laminar component In a variation of the present invention, the flange of the frame element is fixedly attached to the boundary region of the opening of the laminar component, the connection advantageously being produced through welding, riveting, clawing, and/or flanging. This ensures that the fitting device is fixed in place and only the basic body may move together with the tube-shaped work-piece in relation to the laminar component. The flange may be formed from multiple layers of the frame element, for example, from two layers which expediently terminate flush at their face sides.

The frame element is arranged in such a way that it holds the basic body. For this purpose, the frame element preferably at least partially encloses a boundary region of the basic body. Care is to be taken in the case that the enclosure is arranged so that the movement freedom of the basic body is not obstructed. The length of the enclosure is to be larger in this case than the maximum play of the enclosed part of the basic body, so that secure mounting of the basic body in the frame element is ensured. Furthermore, it is advantageous if the frame element is arranged as two-layered, the layers being brought together in the boundary region in order to implement the flange. The two layers then spread out toward the middle of the frame element, so that a part of the basic body may be supported between them and they enclose it

In an alternative embodiment, the frame element has an upper and a lower fitting element, which rest at their boundary regions against the laminar component and between which at least a part of the basic body is arranged. Advantageously, both the upper and the lower fitting elements are arranged as planar at least in the opening boundary region, so that they rest flush against the laminar component. The laminar component may also be leveled locally for this purpose.

Furthermore, it is preferable to connect the upper and lower fitting elements to one another by transverse webs, so that the rigidity of the frame element is improved and the upper and lower fitting elements may not shift or twist in relation to one another. In addition, grooves may be provided on the insides of the two fitting devices, which each receive a free end of the web, resulting in an elevation of the long-term stability of the fitting device. The height of the webs is essentially tailored to the thickness of the laminar component, so that no large projections arise on the laminar component. In this implementation, in principle, initially the entire basic body or at least a part of the basic body is movable in relation to the frame element. The frame element may be movable in relation to the laminar component. However, the upper and the lower fitting elements are more preferably attached fixedly to the laminar component through welding, riveting, clawing, and/or flanging, through which the stability of the fitting device is further increased.

The fitting device according to the present invention is expediently installed by assembling the individual components or pre-assembled components on the laminar component. For example, firstly the lower fitting element of the frame element is attached to the laminar component, the basic body or at least a part of the basic body is placed, and subsequently the upper fitting element is attached to the diametrically opposing boundary section of the laminar component

In a further preferred embodiment, the frame element is arranged as a part of the basic body. In this case, the frame element expediently essentially consists of an upper and lower fitting element, which are both arranged as planar and are positioned in such a way that their outer edges each rest flush on a diametrically opposing side of the boundary region of the opening of the laminar component. In this arrangement, care should be taken that the two fitting elements are oriented essentially congruent to one another. The two fitting elements are connected to one another on their inner edges, the connection point being arranged at a distance to the laminar component, so that the movement freedom of the frame element and/or basic body is ensured.

The inner edges may be connected to one another in different ways, for example, by inserting and attaching a ring or a disk of suitable thickness. The connection between the inner edges of the fitting elements is especially preferably manufactured from a multilayered clawing, so that an internal bead arises on the frame element, which may be tailored to the thickness of the laminar component through the selection of the number of layers, so that a flush connection again arises. It is especially preferable if the boundary region of at least one fitting element may be bent back and then a part of this bent-back boundary region may be bent forward again. If the inner region of the other fitting element is now bent back once, the bent regions engage in one another, and a clawing may be produced. Simultaneously, a congruent arrangement of the fitting elements is ensured by the specific arrangement. The clawing is expediently performed on the laminar component after one of the fitting elements has been positioned on one side and the other fitting element has been positioned on the diametrically opposing side of the laminar component Alternatively, the inner edges of the fitting elements, which are only flanged on themselves and are not clawed with one another, may also be connected to one another by welding or riveting. The flanging may be performed once or repeatedly, so that the particular fitting element is arranged as either C-shaped or S-shaped. It is also possible to combine a C-shaped fitting element with an S-shaped fitting element

In a further advantageous embodiment of the present invention, the reception region of the basic body for the tube-shaped workpiece is arranged as a passageway in the basic body. The size and the shape of the passageway are preferably essentially tailored to the tube-shaped workpiece in this case, so that the basic body rests against the tube-shaped workpiece. This implementation is especially advantageous if the tube-shaped workpiece projects beyond the laminar component and must be guided through it.

Furthermore, it is advantageous for the passageway of the basic body to be arranged as a hollow pipe. socket which is open at both face sides, through which the tube-shaped workpiece is guided. In this embodiment, the stability of the mounting of the tube-shaped workpiece in the fitting device is elevated further. Alternatively or additionally, it is preferable for the passageway region to be provided with a thread into which the tube-shaped workpiece may be screwed using a fitting counter thread. Through the threaded connection, both the overall rigidity of the system and also the tightness between disk element and tube-shaped workpiece are elevated further. The threaded connection may also be used in this case for the purpose of attaching the laminar component to another component and simultaneously providing sufficient tolerance for this attachment via the fitting device.

In an alternative embodiment of the present invention, the basic body is not provided with a passageway opening, but rather the reception region of the basic body has a fastening element, through which the tube-shaped workpiece is attached to the basic body. The fastening element is preferably arranged as a screw. This embodiment is especially advantageous if the tube-shaped workpiece is positioned resting against the laminar component

The fastening element of the reception region of the basic body may also be arranged as a clamping apparatus. The tube-shaped workpiece may thus be attached by clamping to the basic body. This is especially advantageous if frequent replacement or removal of the tube-shaped workpiece is to be expected.

In a further preferred embodiment, the reception region of the basic body is arranged as a bearing bush. It is advantageous in this case that the mounting of the tube-shaped workpiece in a bearing bush is very stable. To additionally elevate the rigidity of die connection, the tube-shaped workpiece may be fixedly connected to the bearing bush of the reception region.

At least one buffer is expediently positioned within the bearing bush, so that vertical movements of the tube-shaped workpiece or the laminar component which may be caused by vibrations of the internal combustion engine facility are compensated for, without damage of the tube-shaped workpiece occurring. It is preferable for the buffer to be arranged as a wire cushion, since this may be manufactured easily and cost-effectively. However, it may also be a suitable elastomeric material.

In a further preferred embodiment, the boundary region of the opening of the laminar component is arranged on at least one side as a recess in the laminar component The thickness of the recess is expediently arranged in this case in such a way that it essentially corresponds to the thickness of the fitting element of the frame element resting against the corresponding side of the laminar component This has the advantage that the fitting device does not project and the surface of the laminar component is planar. If the laminar component is a heat shield, for example, the heat shield is typically 1.1 mm to 1.6 mm thick. Furthermore, in this case the thickness of a fitting element of the frame element resting against the heat shield is approximately 0.2 mm to 0.4 mm. Correspondingly, in this case die heat shield was made 0.2 mm to 0.4 mm (or 0.4 mm to 0.8 mm in the case of recesses on both sides) thinner in the boundary region of the opening than in the remaining region. In the case of heat shields manufactured from metal layers, the recess is preferably produced by leveling this region.

The fitting device according to the present invention may be used for fitting arbitrarily many tube-shaped workpieces. For example, multiple reception regions for the reception of one tube-shaped workpiece each may be provided on a basic body. It is also possible to implement the frame element in such a way that it may receive multiple basic bodies. The number of fitting devices required may thus be reduced for tube-shaped workpieces positioned closely next to one another. The fitting device may be arranged to receive the tube-shaped workpieces from only one side or even from both sides. It may also be arranged to receive different tube-shaped workpieces simultaneously. If the tube-shaped workpieces are guided through the fitting device, they may be introduced into the fitting device from the same side or different sides. A fitting device which receives multiple basic bodies is advantageously formed from two components for easier installation. The two components of the fitting device are preferably arranged as connectable to one another using a bayonet connection in this case.

In principle, the play of the individual parts of the fitting device is restricted. The play is delimited by geometric conditions such as the size of the opening in that laminar component, the diameter of the tube-shaped workpiece, etc. In addition, in the event of unlimited play, the coherence of the individual components of the fitting device would not be ensured. Therefore, it is expedient to provide at least one limit stop in each movement direction of at least one part of the basic body. The limit stops delimit the play of the at least one part of the basic body and hold it in the fitting device.

The basic body is not restricted in principle to a specific shape, as noted. It may be arranged in relation to the frame element in such a way that a movement of at least the part of the basic body which is movable in the movement plane is only possible along one direction of the movement plane. This may be advantageous in particular if the tube-shaped workpiece to be received is subjected to movements in only one direction of the movement plane. In this case, strains are avoided through the movement clearance along one direction, and stable mounting is simultaneously ensured by avoiding unnecessary play along the other direction of the movement plane.

In a preferred embodiment of the invention, the basic body is provided with a one-piece configuration. The construction of the fitting device is thus less complex and the manufacturing is simplified. The installation and/or uninstallation is also made easier by the one-piece configuration of the basic body, since the work step of joining multiple components to a basic body is dispensed with. Because of the one-piece configuration, the basic body is movable as a whole in the movement plane. The basic body provided with a one-piece configuration is preferably arranged as a disk element, since this basic shape is especially suitable for use on laminar components.

In principle, the disk element is not restricted to a specific shape. However, it is advantageously arranged as round, oval, or polygonal, the frame element holding the disk element being arranged as tailored to the selected shape of the disk element. Furthermore, if polygonal disk element are used, it is advantageous for the rotational ability of the disk element to be able to be restricted. The disk element may additionally be arranged as flat over only a partial region, i.e., only where it is necessary for the mobility in the disk plane, for example, in the outer boundary region. In the remaining regions, the disk element may have its height built up.

In a further embodiment, the disk element is arranged as multilayered. As a function of the particular shape and design of the disk element, a multilayered construction may simplify the manufacturing processes and the installation and contribute to the disk element corresponding better to the frame element. It is also possible to implement only partial regions of the disk element as multilayered.

To improve the coverage of the opening in the laminar component by the fitting device, it is expedient for at least one side of the disk element to have a bead in the passageway region. In this way, the tightness in the connection region between tube-shaped workpiece and fitting device is elevated.

The frame element is expediently arranged in such a way that it encloses the boundary region of the disk element. As mentioned before, it is to be ensured in this case that the enclosure is arranged in such a way that the movement freedom of the disk element is not obstructed. The length of the enclosure is to be larger in this case than the maximum play of the disk element, so that secure mounting of the disk element in the frame element is ensured.

In another preferred embodiment of the invention, the basic body comprises two parts, which are separate per se, that form the basic body together. In this way, the flexibility of the fitting device and its adaptability to the installation conditions are improved. The first and the second part of the basic body may each have a one-piece configuration or even be arranged from multiple individual elements, particularly as multi-layered. When the fitting device is installed, the first and the second parts may already be pre-installed and assembled into the basic body or the assembly may be performed only after the installation. At least the first part of the basic body is arranged in such a way that it is movable essentially in the movement plane.

The first part of the basic body is advantageously arranged so it is additionally movable out of the movement plane, particularly by an angle of at most 15°, preferably at most 10°, especially preferably at most 6°. In this way, the first part of the basic body may also yield completely in relation to forces acting on the fitting device which do not act exclusively in the movement direction, but rather also slightly diagonally thereto. Since the first part is also movable out of the plane, a tolerance for transverse force components of the acting force in relation to the movement plane may also be provided, through which strains arising in the laminar component may be reduced even better. The first part of the basic body is preferably only movable out of the plane by at most one of the above-mentioned maximum angles, since otherwise the construction of the fitting device becomes complex. However, a larger angle offset is also possible in principle.

For a two-piece construction of the basic body, at least the second part is expediently movable transversely to the movement plane. The tolerance for the movements of the tube-shaped workpiece to be received by the basic body is thus enlarged. The basic body is arranged to transmit its movement freedom to the tube-shaped workpiece. In addition to movements in the movement plane, the tube-shaped workpiece may also move transversely to the movement plane, through which strains due to manufacturing tolerances, travel-caused vibrations, or temperature-dependent expansions of the components are reduced further and the installation and uninstallation of the tube-shaped workpiece is simultaneously made easier. The movement transverse to the movement plane comprises all movements which do not lie in the movement plane itself. The movement transverse to the movement plane may be executed linearly, in a plane, or spatially. The transverse movement is preferably executed at an angle of 45° to 135°, especially preferably at an angle of 70° to 110° in relation to the movement plane.

As noted, the second part of the basic body is movable transversely to the movement plane of the first part of the basic body. Since the movement plane is arranged parallel to the laminar component in the region of the opening, the second part of the basic body is therefore also movable transversely to the laminar component The transverse movement preferably occurs essentially orthogonally to the movement plane of the first part. Since lambda probes which project through the heat shield are frequently positioned essentially orthogonally to the opening plane of the opening in the heat shield, for example, a corresponding arrangement of the second part of the basic body is often advisable.

In principle, the first part of the basic body is not restricted to movement in the movement plane and the second part of the basic body is not restricted to movement transverse to the movement plane. Therefore, both the first part and also the second part of the basic body may be movable in the movement plane and transversely to the movement plane. Multiaxial movements may also be executed in order to compensate for simultaneously occurring longitudinal, transverse, and/or tilting movements. The multiaxial movement may be executed in this case by only one of the two parts alone or by a combination of the movements of the two parts. In order to ensure sufficient guiding of the individual parts of the basic body, it is preferable if, for the first alternative, only a further part of the basic body is movable transversely to the plane and, for the second alternative, only a further part of the basic body is movable in the movement plane. The part of the basic body which is movable both in the movement plane and also transversely thereto is preferably arranged as integrated into the other part of the basic body. This part of the basic body is supported in such a way that it is moved along either in the movement plane or in the direction transverse to the movement plane by movements of the other part of the basic body and may perform the other type of movement independently. This means that the part arranged as integrated is supported in the other part essentially without play in its movement direction. In this way, the construction of the fitting device is simplified and its tightness is increased.

In principle, either the first part of the basic body or the second part of the basic body may receive the tube-shaped workpiece. Correspondingly, the tube-shaped workpiece is thus either held by the part which moves laterally in the movement plane (i.e., the first part), or by the part which executes the movement transverse to this plane (i.e., the second part). In this case, the one part of the basic body preferably has an opening, particularly positioned centrally. The region around the opening is arranged in this case in such a way that the other part of the basic body which receives the tube-shaped workpiece is received in the manner of a displaced restraint. In addition, the other part expediently also has an opening, particularly positioned centrally, which is arranged to receive the tube-shaped workpiece.

Depending on which part holds the tube-shaped workpiece, a different relative arrangement of the first and second part and frame element to one another is expediently selected. If the tube-shaped workpiece is held by the first part, the first part is expediently supported on the second part of the basic body and this in turn is supported on the laminar component via the frame element. The movement in the movement plane is preferably achieved in a first variation in that the first part of the basic body has a fork-like boundary region, which encloses a boundary region of the second part while leaving a gap between the diametrically opposing abutting faces of both parts. Alternatively, the second part of the basic body may have a fork-like boundary region, which encloses a boundary region of the first part while leaving a gap between the diametrically opposing abutting faces of both parts. If the second part carries the workpiece, it is expediently supported on the first part of the basic body and this in turn is supported via the frame element on the laminar component, the frame element either being movably supported on the opening edge of the laminar component in the movement plane or the second part being movably supported on the frame element in the movement plane. The movable mounting in the movement plane may be performed as described above in connection with the implementation of the frame element or the movable mounting of at least the part of the main body. Principally, it is also possible to have the frame element enclose both parts of the basic body.

To execute the transverse movement (i.e., transverse to the movement plane of the first part), the second part is preferably displaceably restrained, as noted. For this purpose, it expediently has a tubular section, which interlocks with a tubular section of the first part or of the frame element. Both tubular sections are mutually displaceable in the axial direction, which corresponds to the transverse movement of the second part In order to prevent one tubular section from slipping out of the other, both tubes expediently have a limit stop in the region of their mutually inserted ends. In an especially simple implementation, these may be formed by angling the end regions of the tubular sections. In this case, the end region of the inner tube is bent outward and the end region of the outer tube is bent inward, so that both limit stops hit one another when the tubular sections are pulled furthest apart In principle, it does not matter which tubular section lies on the inside and which lies on the outside.

In order to also prevent pushing out on the diametrically opposing side, a further limit stop may be provided there. This may be a lock washer clamped to the holding device in the face-side end region of the tubular section. By using a lock washer, the limit stop may be installed easily on the tubular section without using additional tools and is simultaneously securely held on the section by the clamping.

To suppress and/or restrict the rotation of the tubular sections in relation to one another and/or to delimit the displacement path, at least one groove may be arranged in the first or second part and at least one corresponding web may be arranged in the other part. For example, if the width of a groove essentially corresponds to the width of a web, the rotational ability of the tubular sections in relation to one another may be suppressed by engaging the web in the groove. If the groove is arranged as wider than the web engaging therein, the rotational ability is not suppressed completely, but rather restricted.

Furthermore, the grooves and/or the webs may be arranged having different depths and/or heights, through which the displacement path of one tubular section in the other in the axial direction may be restricted. Through appropriate implementation of the grooves, these may act as limit stops for the webs, through which not only is the longitudinal displacement restricted, but rather one tubular section may also be held in the other. In such an embodiment, the implementation of separate peripheral limit stops may be dispensed with. In principle, grooves and webs of different shapes and lengths may be arranged in a fitting device. Preferably, two essentially identical, diametrically opposing webs are arranged on one of the tubular sections. Multiple pairs of grooves are arranged on the other component, the grooves of a particular pair of grooves being arranged as essentially identical and positioned diametrically opposing. In contrast, the various pairs of grooves are each arranged as different from one another, so that by inserting the webs into different pairs of grooves, the displacement path and/or the rotational range of the tubular section carrying the webs is changeable. For example, two pairs of grooves of different lengths having an angle of 90° between the individual grooves may be distributed uniformly around the circumference of the tubular section, longer and shorter grooves alternating. However, more than two different groove lengths and angles different from 90° are also conceivable.

With the mounting of the second part of the basic body described, it is linearly displaceable in one direction, and the mounting may simultaneously absorb restraining torques. The second part of the basic body is thus displaceably restrained in the first part of the basic body or in the frame element in a mechanical sense. Optimum guiding of the second part of the basic body in the movement direction transverse to the movement plane is thus ensured, and tipping of the tube-shaped workpiece in relation to the movement plane is simultaneously prevented. The danger of damage to the tube-shaped workpiece is thus reduced.

The second part of the basic body is preferably given a pot-like configuration. The basic geometrical shape of the pot is expediently tailored to that of the complementary tubular section, and the dimensions of the top are selected in such a way that its side walls rest approximately flush against the inner or outer lateral surface of the tubular section of the first part or frame element. This ensures that the pot-like second part of the basic body may be moved or displaced in the longitudinal direction of the tubular section, but tilting is simultaneously prevented. The height of the pot expediently essentially corresponds approximately to the height of the tubular section, so that the entire length of the pot may be inserted into the tubular section.

For reception of the tube-shaped workpiece in the pot-like second part of the basic body, it is expedient to provide a passageway in its floor region. Furthermore, it is preferable to implement a sealing element, such as a bead, on at least one side of the floor region of the pot in the region of the passageway. In this way, the tightness in the connection region between tube-shaped workpiece and fitting device is elevated.

The tubular section on the first part or the frame element is expediently manufactured by bending over an inner boundary region of the particular part. It is advantageous in this case that the manufacturing of the tubular section may be performed without adding an additional component, through which the manufacturing process of the fitting device is simplified overall.

Preferred embodiments of the present invention will be explained in the following on the basis of the attached drawing.

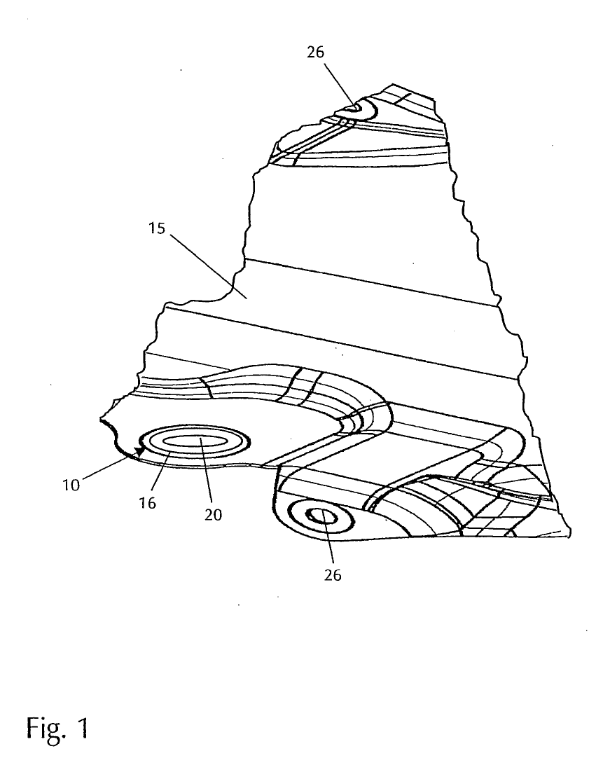

FIG. 1 schematically shows a perspective view of a partial region of a heat shield having an integrated fitting device having a perforated disk;

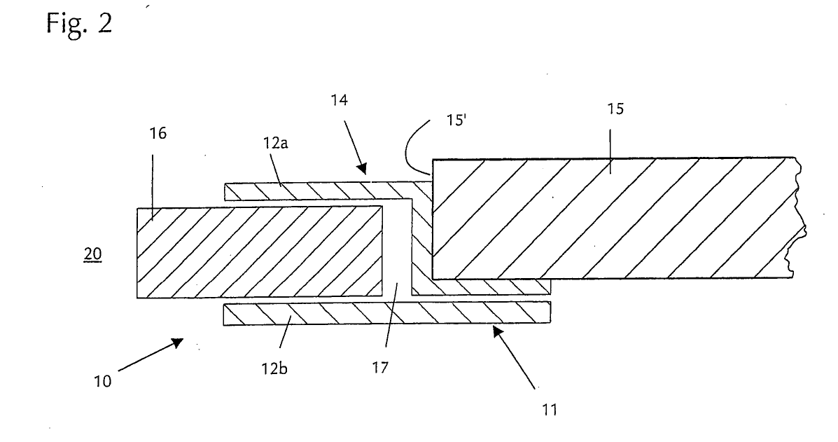

FIG. 2 schematically shows a sectional side view of a partial region of a fitting device having a flange resting against the laminar component;

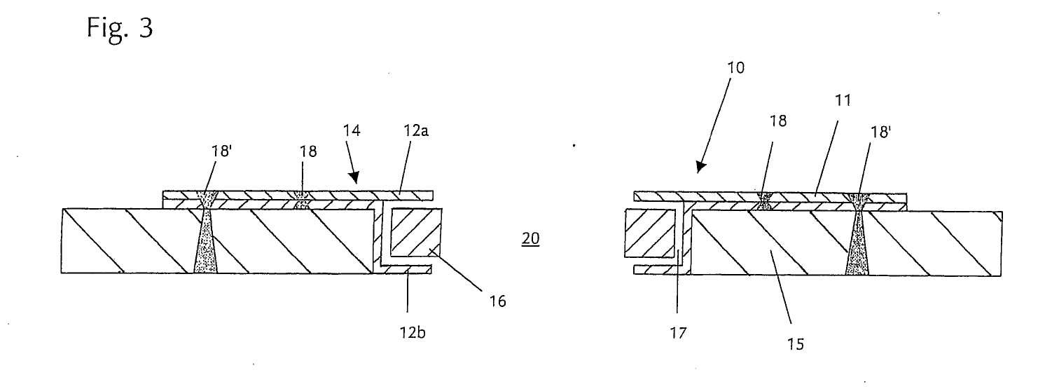

FIG. 3 schematically shows a sectional side view of a fitting device having a flange resting against the laminar component in the welded state;

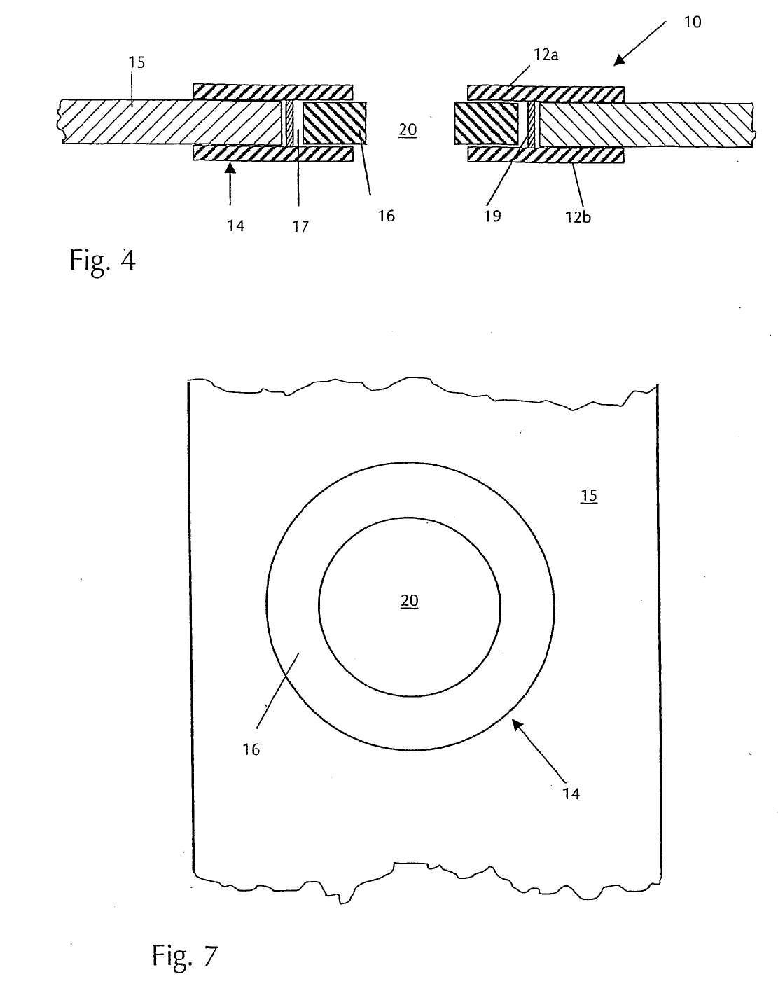

FIG. 4 schematically shows a sectional side view of a fitting device having an upper and lower frame element, connected by transverse webs;

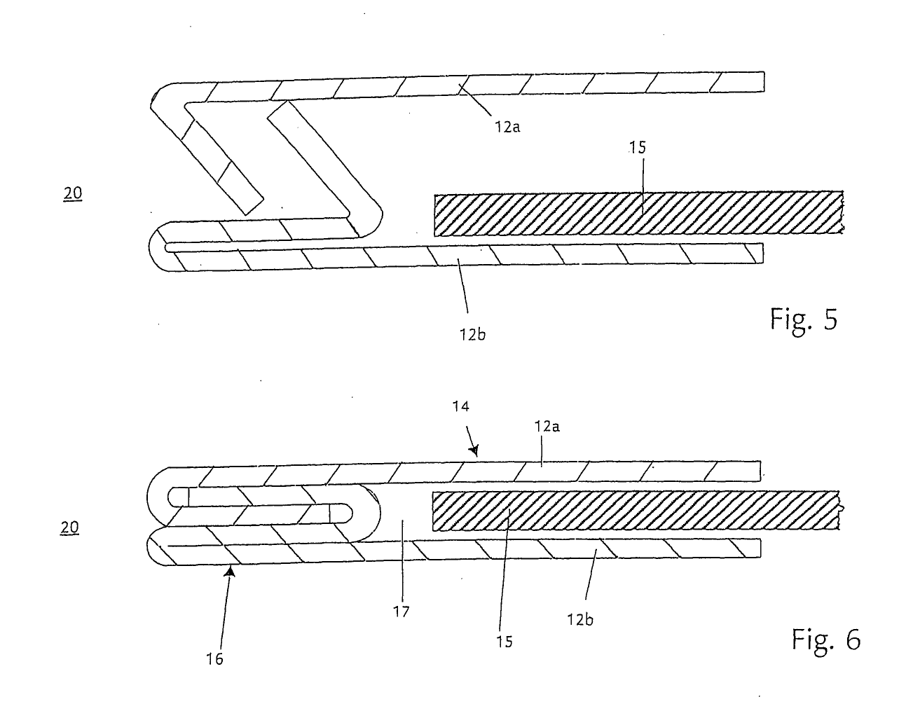

FIG. 5 schematically shows a sectional side view of two fitting elements of a frame element, to be connected to one another through clawing, in the non-clawed state;

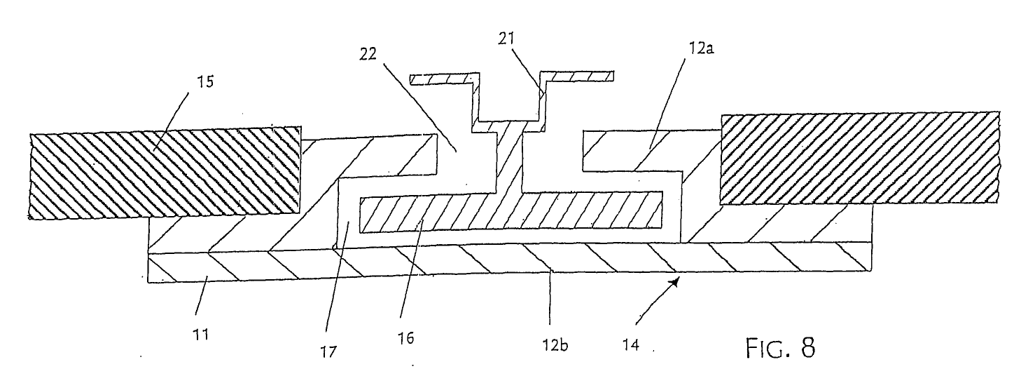

FIG. 6 schematically shows the fitting device from FIG. 5 in the clawed state;

FIG. 7 shows a top view of a fitting device attached to a heat shield having a perforated disk;

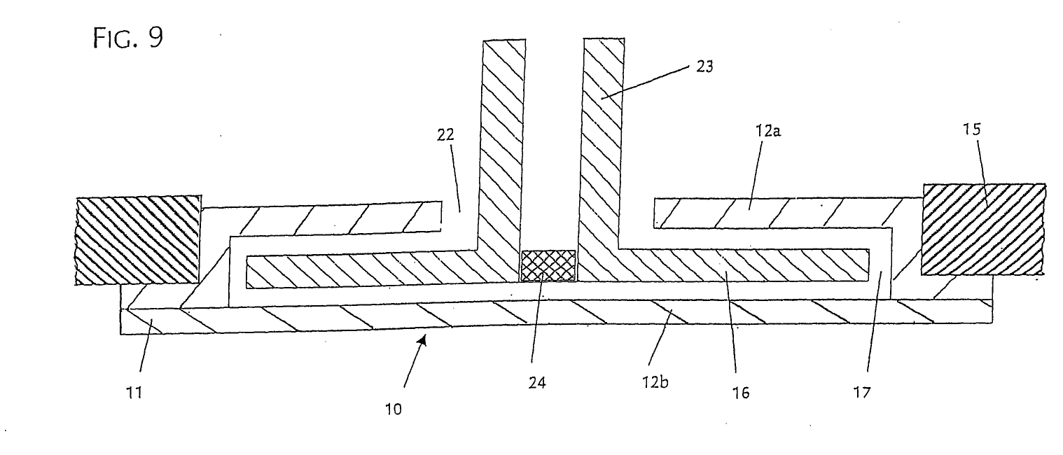

FIG. 8 schematically shows a sectional side view of a fitting device having a clamping apparatus in the reception region of the disk element;

FIG. 9 schematically shows a sectional side view of a fitting device having a bearing bush and buffer in the reception region of the disk element;

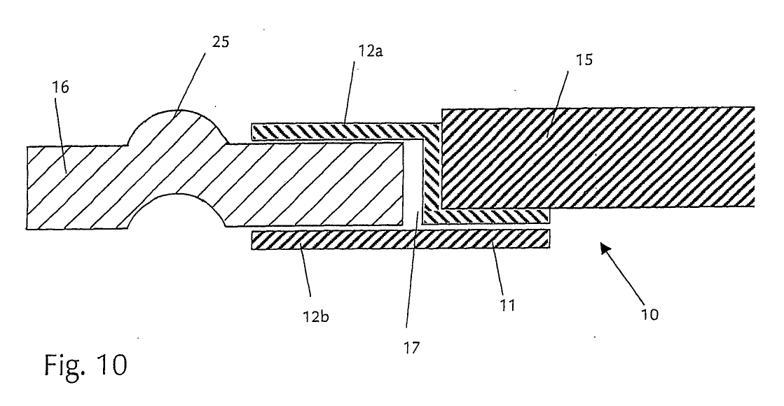

FIG. 10 schematically shows a sectional side view of a partial region of a fitting device having a bead on the disk element;

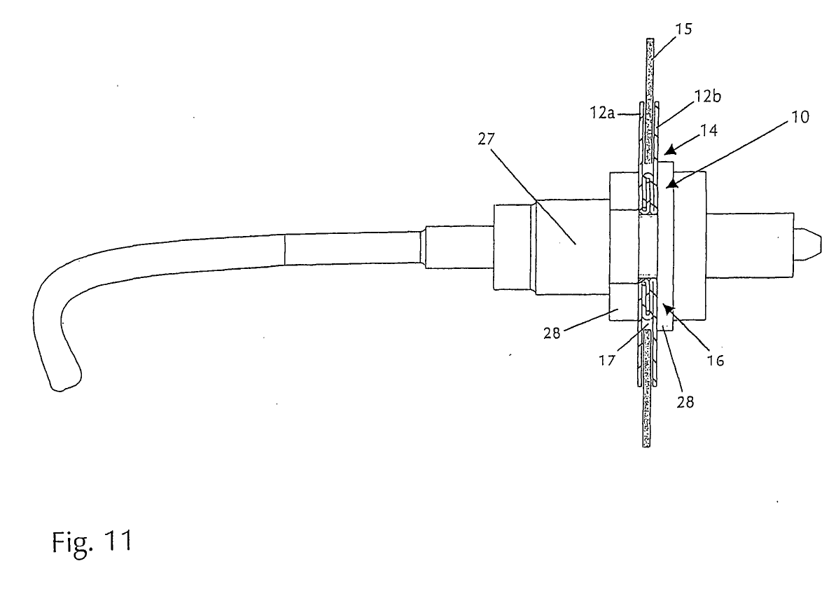

FIG. 11 schematically shows a sectional side view of a fitting device having a perforated disk and a lambda probe guided through the perforated disk;

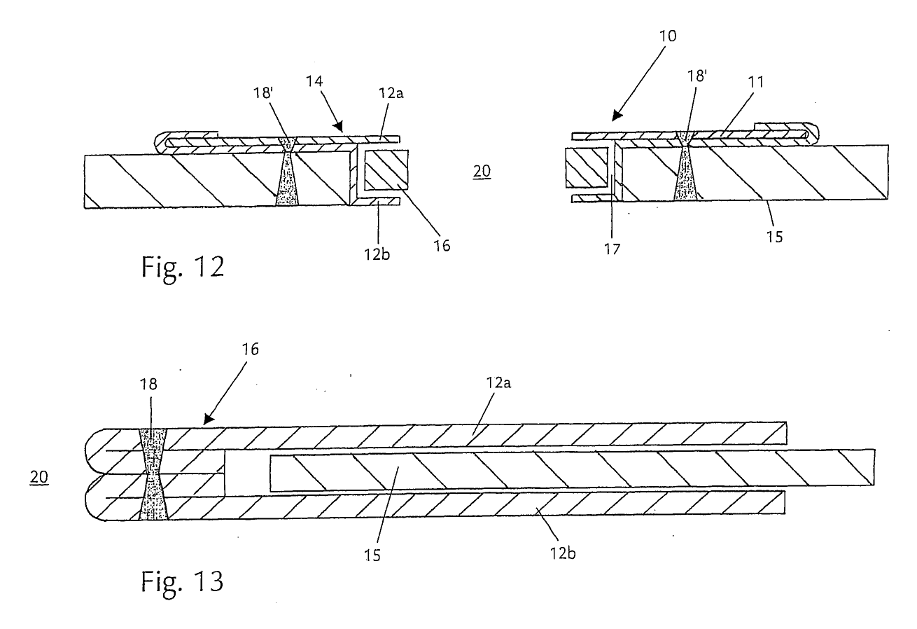

FIG. 12 schematically shows the fitting device from FIG. 3 with a bent flange;

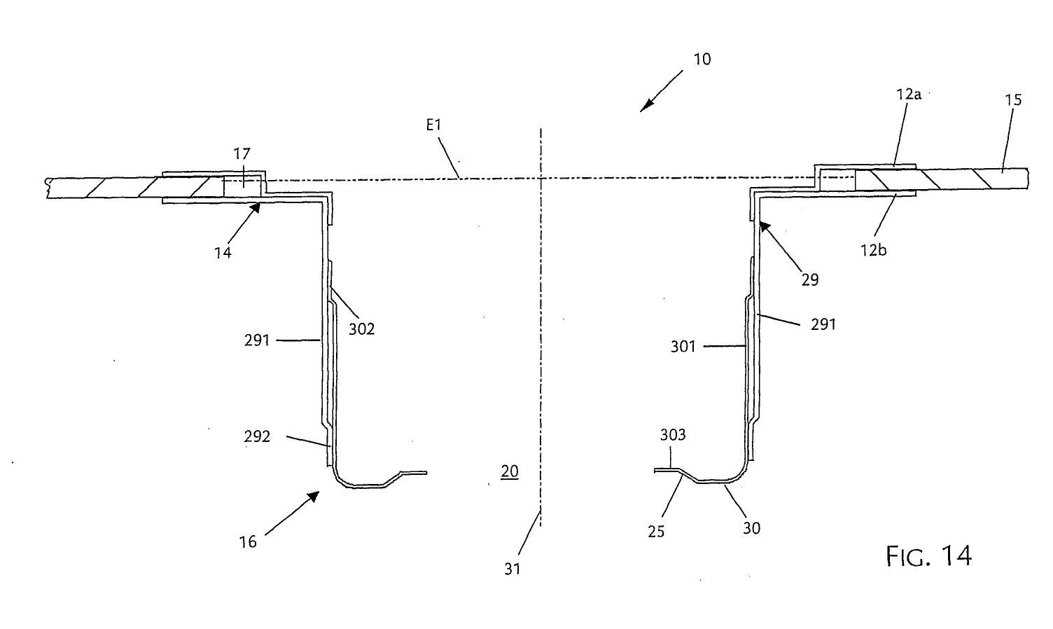

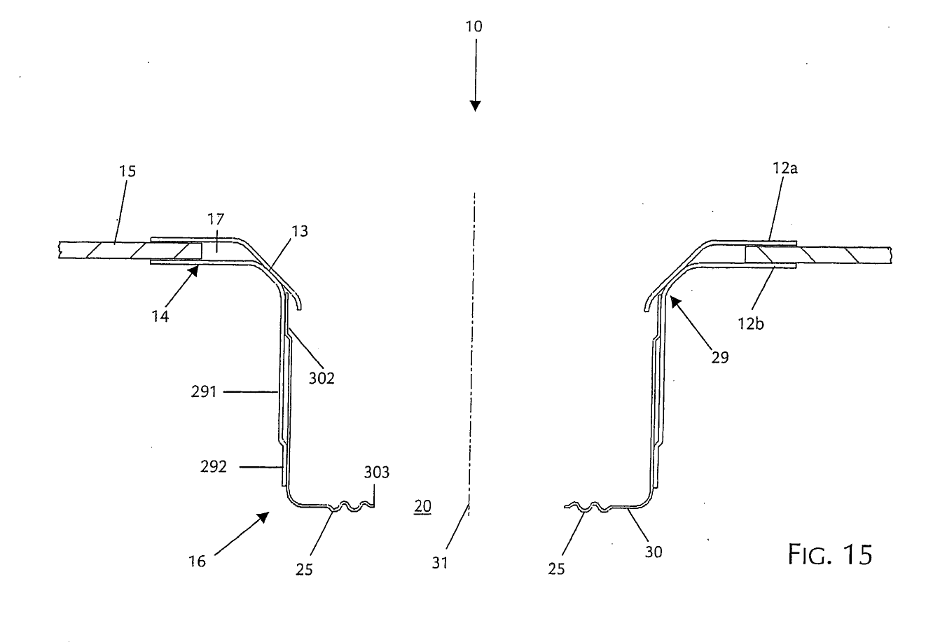

FIG. 13 schematically shows a sectional side view of two fitting elements of a frame element, which are bent over on themselves on their inner edges and welded to one another;

FIG. 14 schematically shows a sectional side view of a fitting device, which is attached in the opening region of a heat shield and has a bead;

FIG. 15 schematically shows a sectional side view of a further fitting device having multiple beads;

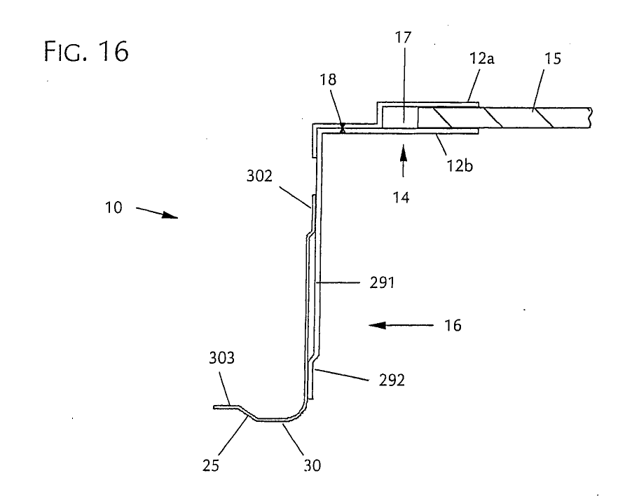

FIG. 16 schematically shows a sectional side view of a partial region of a fitting device according to a further embodiment of the present invention;

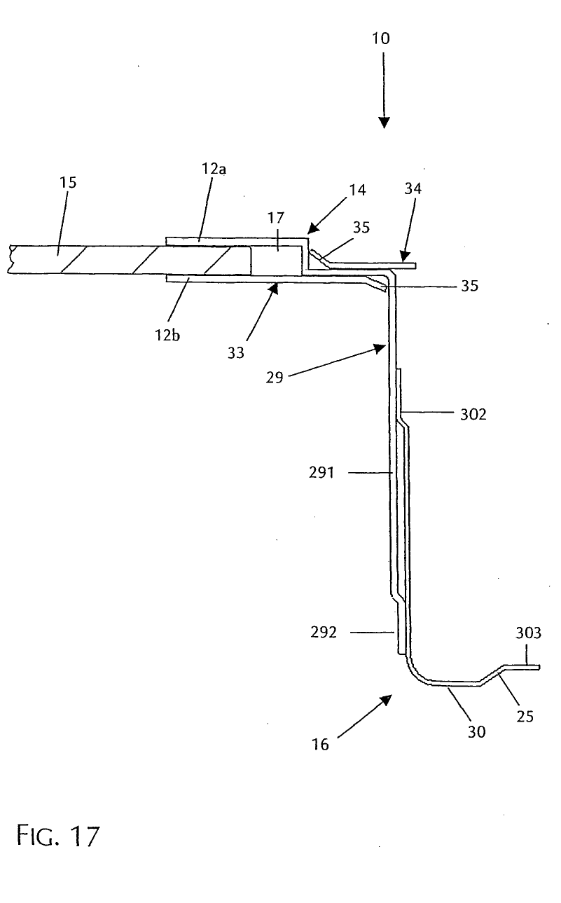

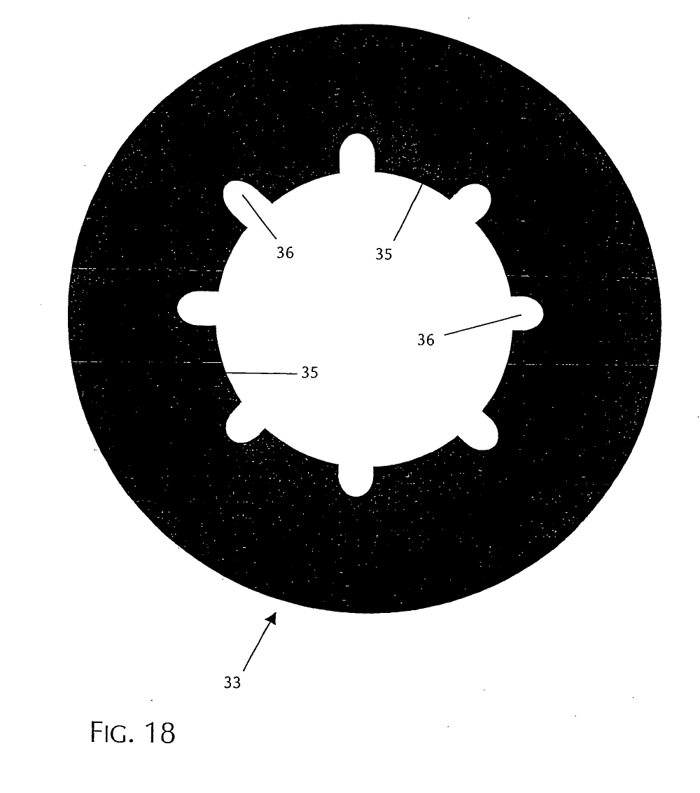

FIG. 17 schematically shows a sectional side view of a partial region of a fitting device according to a further embodiment of the present invention;

FIG. 1 8 schematically shows a top view of a lock washer;

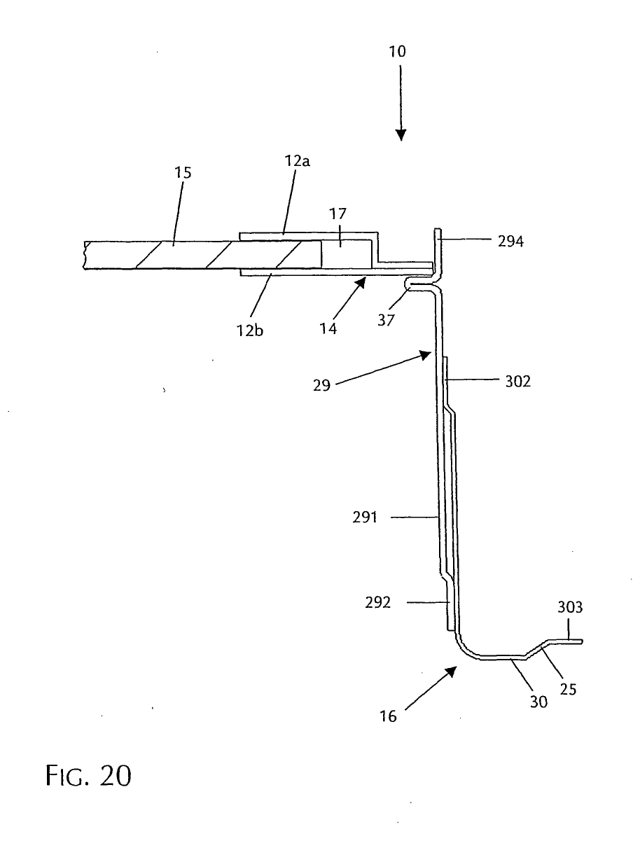

FIG. 19 schematically shows a sectional side view of a partial region of a fitting device according to a further embodiment of the present invention;

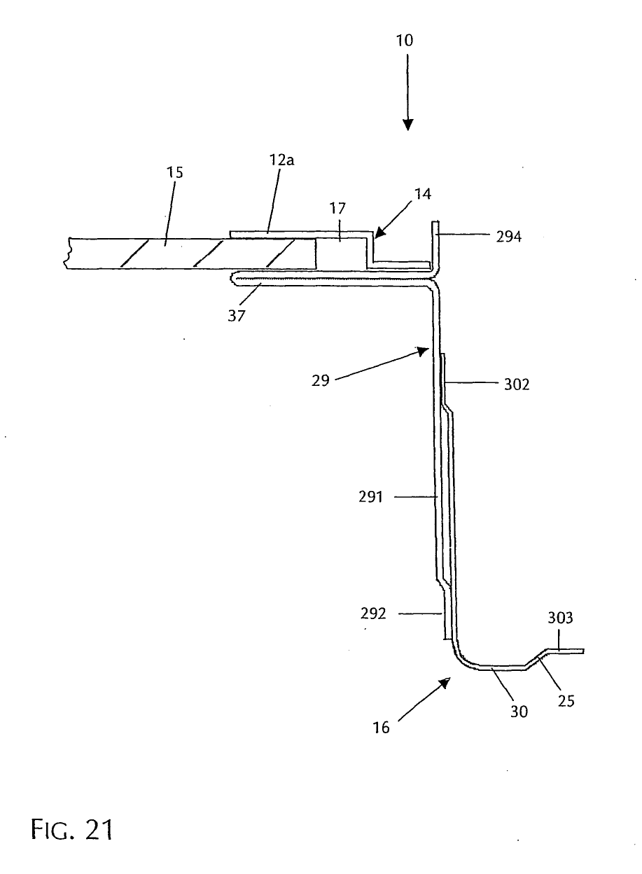

FIG. 20 schematically shows a sectional side view of a partial region of a fitting device according to a further embodiment of the present invention;

FIG. 21 schematically shows a sectional side view of a partial region of a fitting device according to a further embodiment of the present invention;

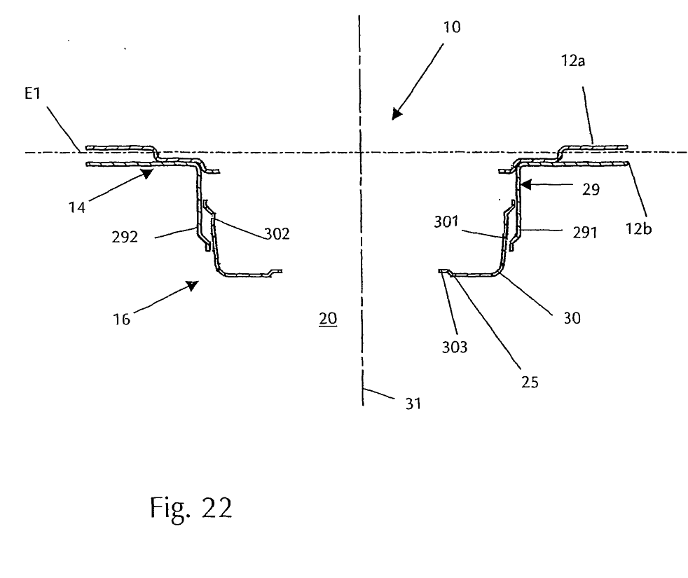

FIG. 22 schematically shows a sectional side view of a further fitting device having a shortened second part;

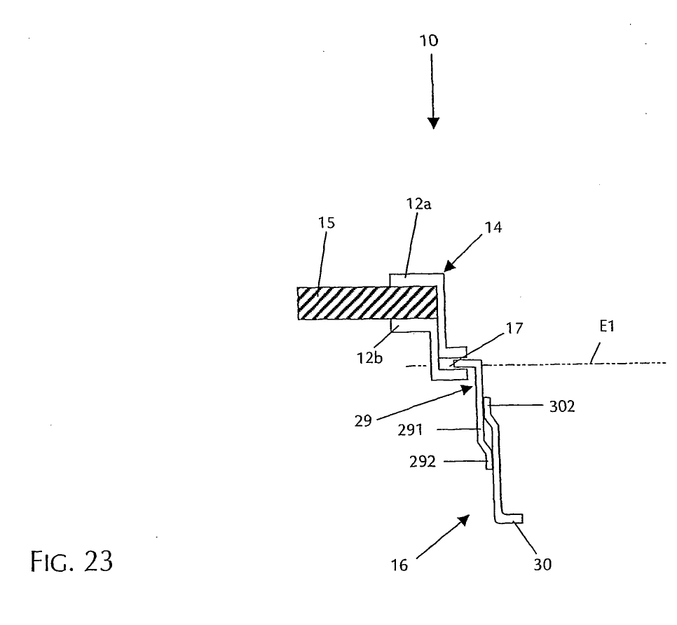

FIG. 23 schematically shows a sectional side view of a fitting device having a movement plane displaced out of the opening plane;

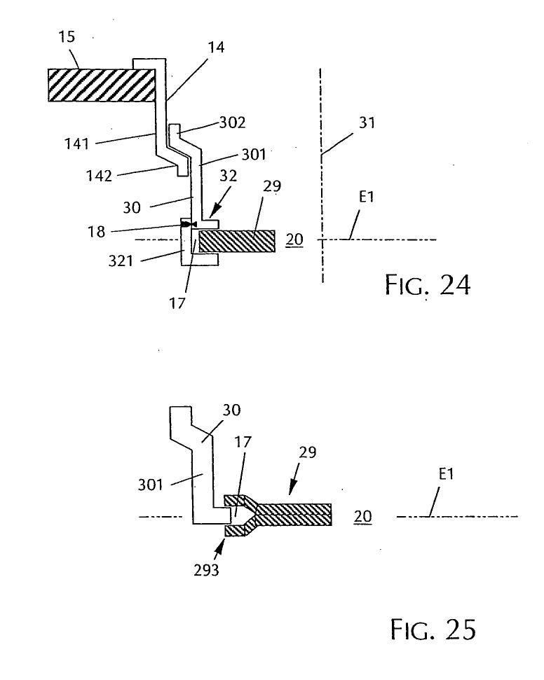

FIG. 24 schematically shows a sectional side view of a partial region of a fitting device according to a further embodiment of the present invention;

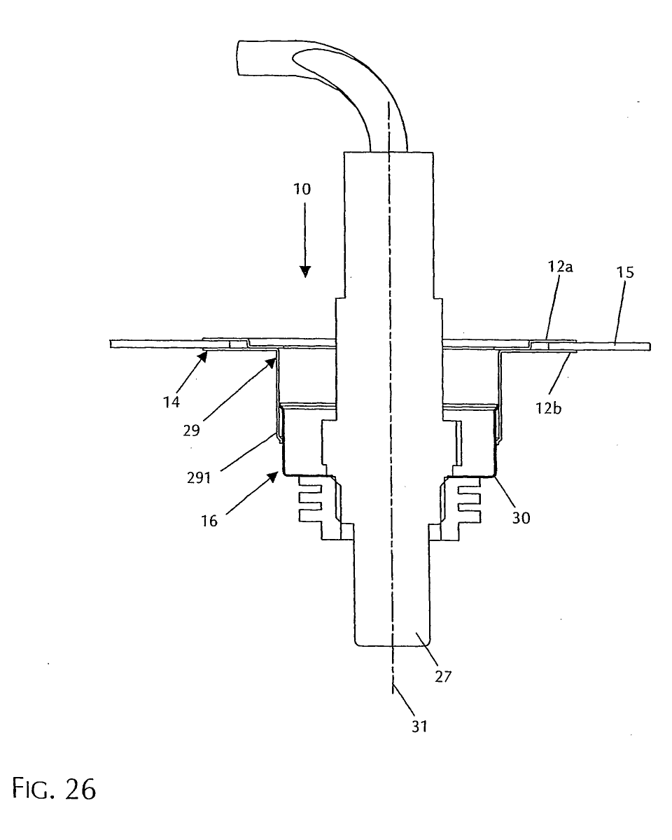

FIG. 25 schematically shows a further fitting possibility in the fitting device shown in FIG. 24;

FIG. 26 schematically shows a sectional side view of a fitting device having a lambda probe guided through the fitting device; and

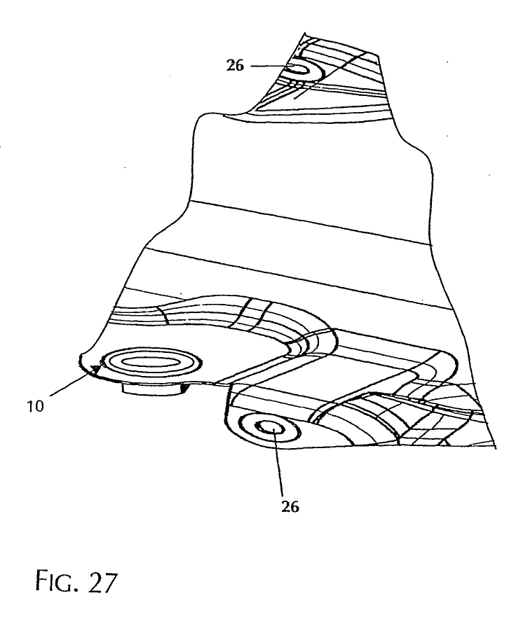

FIG. 27 schematically shows a partial top view of a heat shield having a fitting device according to the present invention.

In the different embodiments illustrated in the following, identical components are provided with identical reference numbers. Furthermore, it is to be noted that the exemplary embodiments illustrated are not to be considered as limiting the present invention and that the figures are only schematic in character.

The perspective view of a partial region of a laminar component 15 is illustrated in FIG. 1. In the example shown here, the laminar component 15 is a heat shield. A fitting device 10 having a basic body 16, arranged as a perforated disk, which has a passageway 20 for the reception of a tube-shaped workpiece, specifically a lambda probe, is integrated into the heat shield 15. Furthermore, FIG. 1 shows two fastening openings 26 in the heat shield 15, through which the heat shield 15 is fastened to the internal combustion engine facility—for example, in the region of the exhaust manifold. Different possibilities for designing the fitting device 10 are described in connection with the following figures.

FIG. 2 shows a sectional side view of a detail of a fitting device 10 having a peripheral flange 11. The flange 11 comprises edges of the fitting elements 12a, 12b positioned one above the other. Both fitting elements 12a, 12b together form the frame element 14. The fitting element 12a is bent in a Z-shape, and the connection leg rests against the face side 15′ of the circular opening of the heat shield. Only the part of the arrangement on the right of the center of the opening is shown in the illustration, while the left half, arranged mirror-symmetrically is not shown. The interior of the bent fitting element 12a of the flange 11 rests against the laminar component 15. In the figure, the fitting element 12b is at a distance to the fitting element 12a. However, in the completely installed state, both fitting elements lie directly one on top of the other in the region of the flange 11 and are fastened to one another and to the laminar component, through welding, for example.

As may also be inferred from FIG. 2, a basic body 16 arranged as a disk element is mounted between the fitting elements 12a, 12b so it is movable. The disk element is arranged as a circular disk having a round central opening 20. It is placed on the fitting element 12a before the second fitting element 12b is fastened to the fitting element 12a. In this case, the disk element is positioned in such a way that a clearance 17 arises between the lateral edge of the disk element and the frame element 14 as an annular gap. The peripheral positioning of the clearance 17 ensures that the disk element is movable in the movement plane, which corresponds to the disk plane.

A sectional side view of a fitting device 10 having a basic body arranged as a perforated disk and having a peripheral flange 11 is illustrated in FIG. 3. The arrangement essentially corresponds to that in FIG. 1. However, the procedure when installing the fitting device 10 is different. In this case, the fitting device 10 has already been pre-assembled upon installation. This means that the two fitting elements 12a, 12b of the frame element 14 have been welded to one another in the flange region 11 through spot welds 18, after the perforated disk was laid between the two. Subsequently, the fitting device 10 was welded at the locations 18′ to the laminar component 15.

FIG. 4 shows a sectional side view of a fitting device 10 having a frame element 14, which comprises two fitting elements 12a, 12b, each of which rests against the laminar component on diametrically opposing sides and are connected to one another via transverse webs 19. The transverse webs 19 are positioned between the laminar component 15 and the disk element, the transverse webs being positioned at a distance from the basic body 16 arranged as a disk element, so that a clearance 17 arises and the movement freedom of the disk element is ensured. In the embodiment shown here, the frame element 14 is fixedly attached to the laminar component 15. The installation is performed in that the fitting elements 12a and 12b are installed one after another on the heat shield 15, similarly to FIG. 1.

FIG. 5 is a sectional side view of a partial region of the fitting device according to the present invention, similar to that in FIG. 1. However, here the basic body 16 and frame element 14 are not separate components, but rather are arranged as integrated. The fitting device 10 is arranged as a whole as a perforated disk. The frame element 14 comprises an upper and a lower fitting element 12a, 12b, which are clawed to one another at their interior edges, toward the opening 20. The illustration of FIG. 5 shows the frame element 14 in the non-clawed state, after the individual components have already been positioned on the heat shield 15 in order to perform the installation. It may be seen that the inner boundary region of the lower fitting element 12b is bent back at an angle of approximately 180°. In the further course of events, the front region of the inner boundary region of the lower fitting element 12b is bent back again at an angle of approximately 100° to 125°. The inner region of the upper fitting element 12a is bent inward at an angle of approximately 50° to 80°. The bent regions of the two fitting elements 12a, 12b are dimensioned in this case in such a way that they conform to one another. The clawing is performed by pressing the fitting elements 12a and 12b against one another.

FIG. 6 shows the frame element 14 illustrated in FIG. 5 in the clawed state. The clawing of the two fitting elements 12a, 12b is arranged as a friction lock and dimensioned in such a way that the thickness of the inner clawing region is slightly larger than the thickness of the laminar component 15, so that the frame element 14 integrated in the basic body 16 is movable in the movement plane.

FIG. 7 shows a top view of a basic body 16, arranged as a perforated disk, having an integrated frame element 14. In this case, the basic body 16 arranged as a perforated disk has a passageway 20, through which the tube-shaped workpiece is guided.

In FIG. 8, a sectional side view of a fitting device 10 having a basic body 16 arranged as a disk element is illustrated, in which a clamping apparatus 21 is arranged in the reception region. Aside from this, the arrangement is similar to that of FIG. 1. The disk element has no passageway opening for reception of the tube-shaped workpiece here (e.g., the lambda probe), however, but rather is arranged as a closed circular ring disk, to which the clamping apparatus 21 is fastened. The clamping apparatus 21 is arranged in this case in such a way that a tube-shaped workpiece may be connected to the disk element through clamping without further additional fastening elements, such as screws, bolts, etc. The upper fitting element 12a is arranged so that in a central position of the disk element, recesses 22 are provided between the clamping apparatus 21 and the upper fitting element 12a, whose length is greater than or equal to the length of the clearance 17. The movement freedom of the disk element in the movement plane is thus ensured.

FIG. 9 shows a sectional side view of a fitting device 10 having a basic body 16 arranged as a disk element, on whose reception region a bearing bush 23 having an integrated buffer 24 is arranged. The bearing bush 23 is arranged in the example shown as a pipe socket integrated into the disk element, whose side facing away from the disk element is open. The tube-shaped workpiece is inserted into the pipe socket 23 for fastening to the disk element and its face side rests against the buffer 24. The buffer 24 cushions movements of the tube-shaped workpiece or the fitting device 10 in the vertical direction and thus prevents damage to the tube-shaped workpiece.

FIG. 10 shows a sectional side view of a partial region of a fitting device 10 having a basic body 16 arranged as a disk element, on whose surface a bead 25 is arranged, which is used to further improve the seal of the tube-shaped workpiece. Aside from this, the arrangement essentially corresponds to that in FIG. 1. The bead 25 is positioned at a distance to the frame element 14, the distance being greater than or equal to the length of the clearance 17. If this embodiment is positioned in the region of the exhaust gas system of an internal combustion engine facility, for example, the bead 25 is preferably arranged on the side of the basic body 16 facing toward the manifold of the exhaust gas system.

In FIG. 11, a sectional side view of a fitting device 10 having a basic body 16 arranged as a perforated disk having an integrated frame element 14 is illustrated. A tube-shaped workpiece 27, which is a lambda probe in the embodiment shown here, is guided through the passageway of the disk element. Aside from this, the fitting device 10 essentially corresponds to that which is partially shown in FIG. 6. The lambda probe is essentially arranged as fitted to the passageway in the passageway region. Directly above and below the passageway region, the lambda probe has flanges 28, each of which rests against the disk element and thus encloses the fitting device 10. The seal of the tube-shaped workpiece 27 is thus further improved. In order to further elevate the tightness, the disk element may be arranged with a bead (as illustrated in FIG. 10) on its surface in the region of the flange 28.

FIG. 12 shows a fitting device 10 similar to that from FIG. 3, the lower fitting element 12b being folded over in the outer flange region onto the upper fitting element 12a and thus enclosing it. The two fitting elements 12a, 12b are fixedly connected to one another by the folding over and must therefore no longer be welded to one another, in contrast to FIG. 3. The welds 18′ merely represent welding of the fitting device 10 to the laminar component 15.

FIG. 13 is a sectional side view of a partial region of a fitting device 10, similar to that of FIG. 6. However, in this case the inner edges of the fitting elements 12a, 12b facing toward the opening 20 are folded over on themselves and their folded regions rest flatly against one another and are welded to one another by a spot weld 18.

In FIG. 14, the sectional side view of a fitting device 10 is illustrated, which is attached in the opening region of a laminar component 15. In the example shown here, the laminar component 15 is a heat shield. The fitting device 10 comprises a basic body 16, which in turn comprises a first part 29 and a second part 30, provided with a pot-like configuration. The first part 29 is displaceably attached to the laminar component 15 using a frame element 14 arranged as integrated in the first part 29. The frame element 14 comprises an upper and a lower fitting element 12a, 12b, whose outer boundary regions each rest against one side of the laminar component 15 and which are connected to one another by welding in their inner regions facing toward the center line 31 of the fitting device 10. Both fitting elements 12a, 12b are bent downward in their inner region, the lower fitting element 12b projecting relatively far downward and thus forming a tubular section 291. The lower end region 292 of the tubular section 291 is arranged as slightly tapered in relation to the tubular section 291.

The tubular section 291 is essentially cylindrical. Correspondingly, the fitting elements 12a, 12b of the frame element 14 are arranged as circular rings. The region of the welded connection of the fitting elements 12a and 12b to one another is positioned at a distance to the laminar component 15, so that a clearance 17 arises as an annular gap delimited by the upper fitting element 12a, the lower fitting element 12b, and the laminar component 15. The peripheral arrangement of the clearance 17 ensures that the basic body 16 is movable in the movement plane E1 via its first part 29. In the embodiment illustrated in FIG. 14, the movement plane E1 is identical to the plane of the opening in the laminar component 15.

The second part 30 of the basic body 16, which is provided with a pot-like configuration, is also arranged as cylindrical and tailored to the tubular section 291. The tubular section 301 is at least partially enclosed by the tubular section 291. The upper boundary region 302 of the second part 30 provided with a pot-like configuration is offset slightly outward and rests against the interior of the tubular section 291. Furthermore, the side region of the part 30 provided with a pot-like configuration rests against the tapered region 292, which is offset inward. The taper 292 and the expansion 302 are essentially arranged as point-symmetrical to one another and correspond to one another in such a way that when the second part 30 is pulled out of the tubular section 291, the expansion 302 stops at the taper 292. The taper 292 of the tubular section 291 therefore fulfills both a limit stop function and also a guide function. The bent-over inner boundary region of the upper fitting element 12a is used as a limit stop in the upper end region of the tubular section 291.

Due to the guiding of the pot-like second part 30 on the tubular section 291 and/or on the taper 292, only a linear movement of the pot-like 30 along the central axis 31 and/or a rotation around the central axis 31 is possible, i.e., in the direction orthogonal to the movement plane E1. In contrast, twisting around another axis or tilting of the pot-like second part 30 in the first part 29 are avoided.

Furthermore, the pot-like second part 30 of the basic body 16 has an approximately centrally positioned passageway 20 in its floor region for the reception of the tube-shaped workpiece (not shown here). The passageway 20 is arranged as essentially circular. A bead 25 is arranged in the passageway boundary region 303 of the pot-like second part 30. The passageway boundary region 303 is arranged as slightly elevated in relation to the floor region of the pot-like second part 30 by this bead. This elevation 303 is arranged for geometrical adaptation of the pot-like second part 30 to the tube-shaped workpiece, specifically a lambda probe, to be guided through the passageway 20, and thus ensures optimal contact of the pot-like second part 30 on the lambda probe. The bead 25 improves the tightness of the contact of the tube-shaped workpiece (not shown here) on the pot-like second part 30. It is arranged in the example shown in FIG. 14 as a half bead.

FIG. 15 shows a sectional side view of a further embodiment of a fitting device 10. In contrast to the fitting device from FIG. 14, the fitting elements 12a and 12b are not bent directly orthogonally downward at their regions facing toward the central axis 31, but rather have a transition region 13 which runs diagonally downward and toward the central axis 31. The fitting elements 12a and 12b are welded to one another in the transition region 13. The upper fitting element 12a projects diagonally inward above the transition region 13 and is therefore used as the upper limit stop for the offset boundary section 302 of the second part 30. The passageway boundary region 303 of the pot-like second part 30 has a bead 25 on its lower side arranged as a multiple bead. This multiple bead is used for the purpose of improving the tightness of the contact of a tube-shaped workpiece (not shown here) on the pot-like second part 30.

FIG. 16 shows a sectional side view of a detail of a fitting device. The fitting device 10 essentially corresponds to that from FIG. 14. Only the region right of the center line 31 of FIG. 14 is shown. The two fitting elements 12a and 12b are welded to one another using a spot weld 1 8 in the region in which they rest flatly against one another.

FIG. 17 shows a detail of the fitting device 10, similar to that from FIG. 14. In this case, the region left of the center line 31 in FIG. 14 is shown. In contrast to the fitting device from FIG. 14, in the fitting device 10 illustrated in FIG. 17, the tubular section 291 is formed from the bent-over region of the upper fitting element 12a. The lower fitting element 12b comprises a lock washer 33. The lock washer 33 is arranged as an annular disk which has spring projections 35 running diagonally downward on its interior boundary region. The lock washer 33 is pushed over the tubular section 291 from below until it rests against the upper fitting element 12a. By being pushed onto the tubular section 291, a tension is applied to the spring projections 35. The lock washer 33 thus clamps itself against the tubular section 291, and the lock washer 33 is prevented from slipping off of the tubular section 291. The upper limit stop of the tubular section 291 is also arranged as a separate lock washer 34. The mode of operation of the lock washer 34 is analogous to that of the lock washer 33. The lock washer 34 also clamps in relation to the upper fitting element 12a, so that a fixed seat of the lock washer 34 is produced.

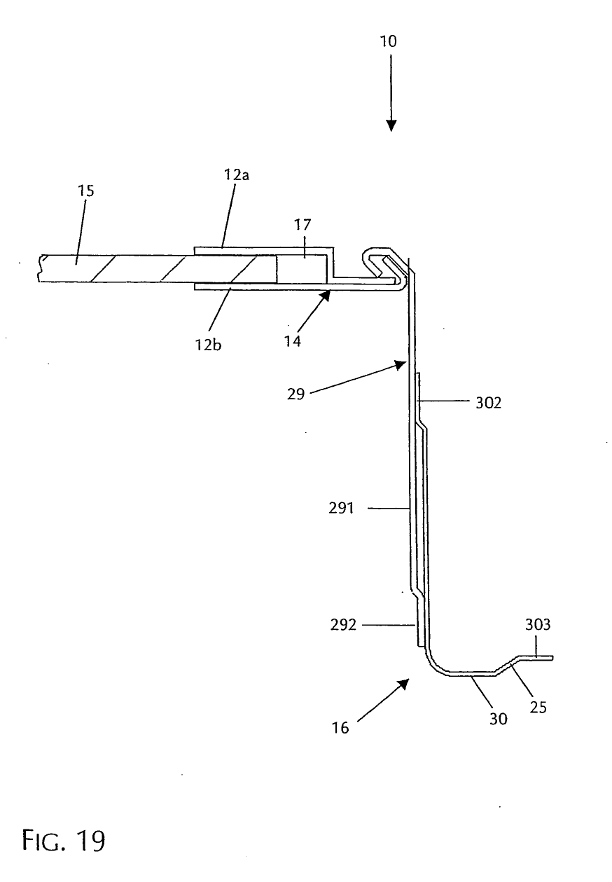

FIG. 18 shows a top view of the lock washer 33, which preferably comprises high-temperature spring steel. It may be seen that recesses 36 are provided positioned at regular intervals around the circumference of the interior edge of the lock washer 33. The recesses 36 are produced through stamping. The section between each the recesses 36 may be bent over due to the presence of the recesses 36, through which the spring projections-35 are produced. The recesses 36 shown in FIG. 18 are each positioned at an angle of approximately 45° to one another, seen from the center point of the lock washer 33.

FIG. 19 shows a sectional side view of a detail of a fitting device 10. In contrast to the embodiments shown above, the frame element 14 is not arranged as integrated in the first part 29 of the basic body 16, but rather as a separate component. The first part 29 is formed by a separate tubular section 291, which is clawed at its upper edge to the inner region of the frame element The illustration in FIG. 1 9 shows the fitting device in the non-clawed state, after the individual components have already been positioned on the heat shield 15 in order to perform the installation. It may be seen that the inner boundary region of the fitting element 12b is bent back at an angle of approximately 120 to 135°. The upper boundary region of the tubular section 291 is bent outward, so that it rests flatly against the bent-back boundary region of the lower fitting element 12b. In the further course of events, the end region of the upper edge of the tubular section 291 projecting beyond the bent-back boundary region of the lower fitting element 12b is bent back again at an angle of approximately 180°. This bent-over end region and the bent-over boundary region of the lower fitting element 12b are dimensioned in this case in such a way that they conform to one another. The clawing is performed by pressing the fitting element 12b against the upper boundary region of the tubular section 291. The fitting device 10 illustrated in FIG. 19 has no upper limit stop for the pot-like second part 30 of the basic body 16. The limit stop may be arranged as a separate component (for example, as a lock washer as shown in the illustration from FIG. 17) and subsequently inserted into the fitting device 10.

FIG. 20 shows a sectional side view of a partial region of a fitting device 10 similar to that from FIG. 19. The two fitting elements 12a, 12b run linearly in their inner boundary region and are not bent out of the opening plane. They terminate flush with one another. The upper boundary region of the tubular section 291 is connected to the inner boundary region of the frame element 14 through flanging. For this purpose, the upper boundary region of the tubular section 291 is first bent outward at an angle of approximately 90° and then bent back again at an angle of 180°. In the further course of events, the upper end 294 of the tubular section 291 is again bent outward by approximately 90°, so that the interior of the tubular section 291 provides a flush lateral surface. A two-layer flange 37 projecting outward at an angle of approximately 90° is produced by the bending. The flange 37 is arranged peripherally. The basic body 16 is positioned in relation to the frame element 14 in such a way that the flange 37 rests flush against the bottom of the inner boundary region of the fitting element 12b. The connection of the basic body 16 to the frame element 14 is performed through flanging of the upper end 294 of the tubular section 291 onto the inner boundary region of the upper fitting element 12a. During flanging of the upper end 294, a radial protrusion may be arranged in the direction of the center line, which is used as a limit stop for the second part 30.

FIG. 21 shows the sectional side view of a partial region of a fitting device 10 similar to that from FIG. 20. In contrast to the fitting device from FIG. 20, the fitting device 10 illustrated in FIG. 21 only has an upper fitting element 12a and no lower fitting element in the frame element 14. The lower fitting element is replaced by a flange 37 which projects far outward from the tubular section 291, and which is manufactured in accordance with the flange from FIG. 20. The flange 37 and the upper fitting element 12a are dimensioned in such a way that they correspond to one another. They may also be fastened to one another by flanging the upper end 294 of the tubular section 291 onto the inner boundary region of the fitting element 12a here. Additionally or alternatively thereto, fitting element 12a and flange 37 may be welded to one another. Analogously to FIG. 20, the upper end 294 may also be arranged as a limit stop in the example shown in FIG. 21.

FIG. 22 shows a sectional side view of a further embodiment of a fitting device 10. The fitting device 10 essentially corresponds to that from FIG. 14. The pot-like second part 30 is arranged as flatter than those of the preceding FIGS. 14 through 21, i.e., the lengths of the tubular section 301 of the second part 30 and of the tubular section 291 of the first part 29 are arranged as shortened in relation to the embodiments from the figures cited. The danger exists in principle, with tubular sections 291, 301 that are arranged as relatively long, that in the event of an eccentric force engagement point during the movement of the parts 29, 30, under some circumstances slight canting and/or hooking of the tubular sections 291, 301 with one another may occur. The probability of the occurrence of such canting is reduced in the present embodiment. Therefore, it may be preferable to adapt the height of the pot-like second part 30 in such a way that it essentially corresponds to the maximum deflection of the tube-shaped workpiece to be expected in the direction of the center line 31 and does not significantly exceed this.

FIG. 23 shows a sectional side view of a partial region of a further fitting device 10. In this embodiment, the frame element 14 is not movable, but rather is fixedly attached to the laminar component 15 using welding. The fitting elements 12a and 12b are bent downward by approximately 90° in their inner boundary region and again bent 90° inward in their end regions in the direction of the central axis of the fitting device 10. In the end regions, the fitting elements 12a and 12b are positioned at a distance to one another, so that a clearance 17 results. The bent-over end region of the tubular section 291 of the first part 29 engages in the clearance 17. The end region of the tubular section 291 is movably positioned in the clearance 17. Therefore, the movement plane E1 of the fitting device illustrated here lies on a plane which is parallel and lowered in relation to the opening plane of the opening in the laminar component 15.

FIGS. 24 and 25 show arrangements of the fitting device 10 according to the present invention, in which the relative arrangement of first and second parts and frame element to one another is altered in relation to the preceding embodiments. While in FIGS. 14 through 17 and 19 through 23, the first part 29, which is laterally movable in the movement plane E1, is fastened via the frame element 14 to the laminar component 15 and the second part 30 is held in the first part 29 so it is displaceable in the direction of the center line and is intended for the reception of the tube-shaped workpiece (the lambda probe, etc.), in FIGS. 24 and 25, the first part 29 receives the tube-shaped workpiece. The second part 30 is now fastened via the frame element 14 to the laminar component 15 and in turn holds the first part 29. The displaceability of the second part 30 in the direction transverse to the plane E1 is achieved essentially analogously to the exemplary embodiments already described. Instead of the tubular section 291 of the first part 29, however, a tubular section 141 of the frame element 14 is now used as the guide for the tubular section 301 of the second part 30. Limit stops 142 and 302 prevent the two tubular sections from slipping out of one another.

For the reception of the first part 29, in the embodiment shown in FIG. 24, a fork-like region 32 is arranged at the lower end of the second part 30. For this purpose, the outermost boundary region of the tubular section 301 is bent over essentially orthogonally. In addition, an angled part 321 is attached to the outer lower edge of the tubular section 301 using a spot weld 18. The first part 29 is laid between the two ends of the fork 32 so it is movable. The first part 29 is arranged as disk-shaped and has a central opening 20 for the reception of the tube-shaped workpiece (the lambda probe, etc.). FIG. 24 shows, like all preceding partial sections, only half of the entire section. The other half is positioned in a mirror image to the center line 31. The fork-like region 32 encloses the disk edge of the first part 29 in an annular shape. In this case, an annular gap 17 remains between the diametrically opposing abutting faces of the first and second parts, which allows the play of the first part 29 in the plane El. The upper end of the angled part 321 is used as a limit stop and delimits the movement of the second part 30 upward.

FIG. 25 shows another type of mounting of the first part 29 in the second part 30. Only the lower region of the fitting device is illustrated. The upper region neighboring the laminar component may be arranged as in FIG. 24. In contrast to FIG. 24, the fork-like region 293 is now provided in the first part. For this purpose, it comprises two plates positioned one over another, whose ends are offset in opposite directions and thus form a fork 293 having end regions running essentially parallel to one another. A orthogonally bent-over end section of the tubular section 301 engages in the annular gap 17 thus arising.

In principle, a combination of one of the embodiments from FIG. 24 or 25 with one of the embodiments from one of FIGS. 14 through 17 and 19 through 23 is also possible. In this case, the basic body of a fitting device which is arranged according to one of the embodiments from FIGS. 14 through 17 and 19 through 23 may have a third part, which is positioned in the passageway region of the second part 30 of the basic body and is arranged analogously to the first part 29 of the embodiments from FIG. 24 or 25. Instead of the second part, the third part of the basic body receives the tube-shaped workpiece. The third part is movable along a parallel line of the plane E1 and therefore also parallel to the first part of the basic body. A movement of the basic body in the direction of the plane E1 may therefore be achieved through displacement of the first part, the third part, or a combination of these displacements.

In FIG. 26, a sectional side view of a fitting device 10 is illustrated, which is positioned on a heat shield 15. FIG. 26 shows the essential arrangement of the tube-shaped workpiece in the fitting device according to the present invention and essentially conforms to all arrangements described above according to FIGS. 14 through 25. The overall arrangement is described here with reference to the example of a fitting device essentially corresponding to that from FIG. 14. A tube-shaped workpiece 27, which is a lambda probe in the embodiment shown here, is guided through the passageway of the pot-like second part 30 of the basic body. The passageway is arranged as fitted to the size and shape of the lambda probe 27, so that the lambda probe 27 is attached fixedly and tightly enclosed in the passageway region of the pot-like second part of the basic body 16. An arrangement of this type may be performed in a heat shield, for example, as is partially shown in FIG. 27. The position of the fitting device 10 according to the present invention is in an opening in the left lower region of the detail. The lambda probe is not shown here. Reference numbers 26 identify fastening openings for screws, using which the heat shield is fastened to the internal combustion engine facility - for example, in the region of the exhaust manifold.

1. (canceled)

56. A fitting arrangement, comprising: a fitting device for a tube-shaped workpiece for use in internal combustion engine facilities and a laminar component of an internal combustion engine facility, said fitting device having at least one basic body having a reception area for reception of said tube-shaped workpiece, with said basic body being positioned in an area of an opening of said laminar component, said fitting device being provided with a frame element holding said basic body and being supported in the boundary region of the opening of said laminar component, and said fitting device covering the opening of said laminar component after reception of said tube-shaped workpiece, wherein at least a part of said basic body is essentially movable relative to said laminar component in a plane, which is oriented parallel to the plane of the opening.

57. A fitting arrangement according to claim 56, wherein said laminar component of the internal combustion engine facility is a heat shield.

58. A fitting arrangement according to claim 56, wherein said laminar component of the internal combustion engine facility is a heat shield arranged in the region of an exhaust gas system.

59. A fitting arrangement according to claim 56, wherein said tube-shaped workpiece is a sensor.

60. A fitting arrangement according to claim 56, wherein said tube-shaped workpiece is a lambda probe.

61. A fitting arrangement according to claim 56, wherein at least one of said basic body and said frame element is made of metal or a metal alloy, or of a high-temperature-resistant fiber-reinforced material.

62. A fitting arrangement according to claim 56, wherein the edge of said frame element is arranged as a flange which is supported on said laminar component.

63. A fitting arrangement according to claim 56, wherein the edge of said frame element is arranged as a flange with said flange being fixedly attached to said laminar component by welding, riveting, clawing and/or flanging.

64. A fitting arrangement according to claim 56, wherein said frame element comprises an upper and a lower fitting element which rest at their boundary regions against said laminar component and between which at least a part of said basic body is arranged.

65. A fitting arrangement according to claim 56, wherein said frame element comprises an upper and a lower fitting element which are joined in a flexural-resistant manner with each other by transverse webs, with the length of said webs corresponding substantially to the thickness of said laminar component.

66. A fitting arrangement according to claim 56, wherein said frame element comprises an upper and a lower fitting element with said fitting elements being fixedly attached to said laminar component, and said fitting elements being joined to said laminar component by welding, riveting, clawing and/or flanging.

67. A fitting arrangement according to claim 56, wherein said frame element is integrated in said basic body.

68. A fitting arrangement according to claim 56, wherein said frame element consists of an upper and a lower fitting element which are arranged in a substantially congruent manner relative to each other and each comprise an inner and an outer edge, with said outer edges resting in a movable manner on said laminar component and said fitting elements being fixedly joined to each other in the region of said inner edges and forming at least a part of said basic body.

69. A fitting arrangement according to claim 68, wherein the fixed connection between the inner edges of the fitting elements is formed by a multi-layer clawing of the edges, with one of the edges being formed with at least three layers.

70. A fitting arrangement according to claim 68, wherein the inner boundary region of the fitting elements of said frame element resting against said laminar component are mutually welded and/or riveted.

71. A fitting arrangement according to claim 56, wherein said reception area of said basic body is configured as a passageway in said basic body, with the diameter of said passageway corresponding substantially to the diameter of said tube-shaped workpiece.

72. A fitting arrangement according to claim 71, wherein said reception area of said basic body is configured as a passageway in said basic body, said passageway being a hollow pipe socket which is open at both face sides.

73. A fitting arrangement according to claim 71, wherein said reception area of said basic body is configured as a passageway in said basic body with the region of said passageway being provided with a thread.

74. A fitting arrangement according to claim 71, wherein said reception area of said basic body comprises a fastening element for fastening said tube-shaped workpiece.

75. A fitting arrangement according to claim 71, wherein said reception area of said basic body comprises a fastening element for fastening said tube-shaped workpiece, with said fastening element being configured as a screw or a clamping apparatus.

76. A fitting arrangement according to claim 56, wherein said reception area of said basic body comprises a bearing bush for rigidly connecting said tube-shaped workpiece.

77. A fitting arrangement according to claim 56, wherein said reception area of said basic body comprises a bearing bush for bearing said tube-shaped workpiece with a wire cushion being arranged as buffer between said basic body and said tube-shaped workpiece.

78. A fitting arrangement according to claim 56, wherein said boundary region of said opening of said laminar component is arranged as a recess on at least one side, with the depth of the recess corresponding substantially to the thickness of the fitting element of said frame element corresponding to this side or to the thickness of a flange of said frame element.

79. A fitting arrangement according to claim 56, wherein several of said basic bodies are held by said frame element.

80. A fitting arrangement according to claim 56, wherein at least one limit stop for limiting the movement of said basic body is provided for each direction of movement.

81. A fitting arrangement according to claim 56, wherein at least a part of said basic body can be moved in only one direction of said movement plane.

82. A fitting arrangement according to claim 56, wherein said basic body is provided with a one-piece configuration.

83. A fitting arrangement according to claim 56, wherein said basic body is arranged as a disk element with a substantially round, oval or polygonal configuration.

84. A fitting arrangement according to claim 56, wherein said basic body is arranged as a disk element with a multi-layer configuration.

85. A fitting arrangement according to claim 56, wherein said basic body is arranged as a disk element with a bead on at least one side.

86. A fitting arrangement according to claim 56, wherein said basic body is arranged as a disk element and said frame element encompasses the boundary region of said disk element.

87. A fitting arrangement according to claim 56, wherein said basic body comprises a first part and a second part.

88. A fitting arrangement according to claim 56, wherein said basic body comprises a first part and a second part and wherein said first part of said basic body can be moved about an angle of at most 150 out of said movement plane.

89. A fitting arrangement according to claim 56, wherein said basic body comprises a first part and a second part and wherein at least said second part of said basic body can be moved transversally to said movement plane.

90. A fitting arrangement according to claim 56, wherein said basic body comprises a first part and a second part and wherein at least said second part of said basic body can be moved in the range of 450 to 1350 transversally to said movement plane.

91. A fitting arrangement according to claim 56, wherein said basic body comprises a first part and a second part and wherein said second part of said basic body can be moved substantially orthogonally relative to said movement plane of said first part of said basic body.

92. A fitting arrangement according to claim 56, wherein said basic body comprises a first part and a second part and wherein said first part or said second part of said basic body can be moved both in said movement plane as well as transversally to the same.

93. A fitting arrangement according to claim 56, wherein said basic body comprises a first part and a second part and wherein one of said first and second parts of said basic body can be moved both in said movement plane as well as transversally to the same with the part of said basic body being thus movable is arranged integrated in the respective other part of said basic body.

94. A fitting arrangement according to claim 56, wherein said basic body comprises a first part and a second part and wherein one of said first or second parts of said basic body is arranged for receiving said tube-shaped workpiece.

95. A fitting arrangement according to claim 56, wherein said basic body comprises a first part and a second part and wherein one of said parts of said basic body comprises an opening, in particular an opening that is arranged centrically, with said opening being arranged for receiving in the manner of a displaced restraint of said other part of said basic body which receives the tube-shaped workpiece.

96. A fitting arrangement according to claim 56, wherein said basic body comprises a first part and a second part and wherein said second part of said basic body comprises a tubular section which for a displaceable restraint in a direction transversally to the movement plane interlocks with a tubular section of said first part or of said frame element and is displaceable relative to the same in the axial direction.

97. A fitting arrangement according to claim 96, wherein said tubular sections each comprise a limit stop in the region of their mutually inserted ends arranged as a projecting end region of the respective tubular section, which limit stop prevents them from slipping out.

98. A fitting arrangement according to claim 96, wherein the tubular section of the frame element is formed by bending an inner section of said frame element.

99. A fitting arrangement according to claim 96, wherein said second part of said basic body is provided with a pot-like configuration.

100. A fitting arrangement according to claim 96, wherein said second part of said basic body is provided with a pot-like configuration and wherein the height of said pot-like second part of said basic body substantially corresponds to the height of said tubular section of said first part or of said frame element.

101. A fitting arrangement according to claim 96, wherein said second part of said basic body is provided with a pot-like configuration with the bottom area of the pot-like second part of the basic body comprising a passageway for receiving the tube-shaped workpiece and with a bead being formed in the region of the passageway on at least one side of the bottom area of the pot-like second part of the basic body.

102. A fitting arrangement according to claim 56, wherein said basic body comprises a first part and a second part and wherein said second part is held on said first part of said basic body and the latter is held on said laminar component by way of a frame element, with either said frame element being movably held at the edge of the opening of said laminar component in said movement plane or said second part being movably held on said frame element in said movement plane.

103. A fitting arrangement according to claim 56, wherein said basic body comprises a first part and a second part and wherein said first part is held on said second part of said basic body and said basic body is held on said laminar component by way of a frame element.

104. A fitting arrangement according to claim 103, wherein for a displaceable restraint in a direction of the movement plane the first part of the basic body comprises a fork-like boundary region which encompasses a boundary region of the second part while maintaining a gap between the mutually opposite abutting faces of the two parts.

105. A fitting arrangement according to claim 103, wherein for a displaceable restraint in a direction of the movement plane the second part of the basic body comprises a fork-like boundary region which encompasses a boundary region of the first part while maintaining a gap between the mutually opposite abutting faces of the two parts.

106. A fitting arrangement according to claim 88, wherein said first part of said basic body can be moved about an angle of at most 10° out of said movement plane.

107. A fitting arrangement according to claim 106, wherein said first part of said basic body can be moved about an angle of at most 60 out of said movement plane.

108. A fitting arrangement according to claim 90, wherein at least said second part of said basic body can be moved in the range of 700 to 1100 transversely to said movement plane 109. A fitting arrangement according to claim 61, wherein at least one of said basic body and said frame element is made of copper or steel.
